(19) United States
(12) Patent Application Publication
(10) Pub. No.: US 2026/0323539 A1
(43) Pub. Date: Oct. 15, 2026

(54) METHOD AND APPARATUS FOR CORRECTING SRS-BASED DOWNLINK CHANNEL ESTIMATES BASED ON AN INDICATION OF WHETHER POWER RELAXATION IS COMPENSATED FOR AN UPLINK TRANSMISSION

(71) Applicant: Lenovo (Singapore) Pte. Ltd., Singapore (SG)

(72) Inventors: Colin Frank, Park Ridge, IL (US); John R Mura, Clarendon Hills, IL (US)

(21) Appl. No.: 19/483,533

(22) PCT Filed: May 13, 2024
(86) PCT No.: PCT/IB2024/054656

§ 371 Date: Nov. 11, 2025

Related U.S. Application Data
(60) Provisional application No. 63/466,216, filed on May 12, 2023.

(51) Int. Cl. H04W 52/36; H04L 5/00; H04L 25/02

(52) U.S. Cl. CPC H04W 52/367; H04L 5/0051; H04L 25/0204

(57) ABSTRACT

Various aspects of the present disclosure relate to correcting a sounding reference signal (SRS)-based downlink channel estimate. In some implementations, a user equipment (UE) may include at least one processor coupled with at least one memory and configured to cause the UE to identify a power relaxation for an uplink transmission, determine that the power relaxation is compensated at the UE, and transmit to a base station an indication that the power relaxation is compensated.

### TECHNICAL FIELD

The present disclosure relates to wireless communications, and more specifically to techniques for the correction of downlink (DL) channel estimates based on sounding reference signal (SRS) transmission(s).

### BACKGROUND

A wireless communications system may include one or multiple network communication devices, such as base stations, which may be otherwise known as an evolved NodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) Radio Access Technology (RAT), fourth generation (4G) RAT, fifth generation (5G) RAT, among other suitable RATs beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may identify a power relaxation for an uplink (UL) transmission, determine that the power relaxation is compensated at the UE, and transmit, e.g., to a base station (BS), an indication that the power relaxation is compensated.

Other implementations of the method and apparatuses described herein may receive, e.g., from a UE, an indication of whether a power relaxation is compensated for an UL transmission, determine a set of power relaxation values for the UL transmission, and correct a DL channel estimate based on the set of power relaxation values and further based on the indication.

### BRIEF DESCRIPTION OF THE DRAWINGS

FIG. 1 illustrates an example of a wireless communication system in accordance with aspects of the present disclosure.

FIG. 2 illustrates an example of a protocol stack showing different protocol layers in the UE and network, in accordance with aspects of the present disclosure.

FIG. 3 illustrates an example of compensating the implementation losses at a UE, in accordance with aspects of the disclosure.

FIG. 4 illustrates an example of output power compared to power control with and without compensation of implementation losses, in accordance with aspects of the present disclosure.

FIG. 5 illustrates an example of power differences between sounding reference signal (SRS) ports and power control with compensation of implementation losses, in accordance with aspects of the present disclosure.

FIG. 6 illustrates another example of power differences between SRS ports and power control without compensation of implementation losses, in accordance with aspects of the disclosure.

FIG. 7 illustrates an example of receiver switching and trace losses between the antenna connectors and the Low Noise Amplifiers (LNAs), in accordance with aspects of the disclosure.

FIG. 8A illustrates an example of UE-to-gNB channel measurement, in accordance with aspects of the disclosure.

FIG. 8B illustrates an example of gNB-to-UE channel measurement, in accordance with aspects of the disclosure.

FIG. 9 illustrates an example of a UE in accordance with aspects of the present disclosure.

FIG. 10 illustrates an example of a processor in accordance with aspects of the present disclosure.

FIG. 11 illustrates an example of a network equipment (NE) in accordance with aspects of the present disclosure.

FIG. 12 is a flowchart diagram illustrating one embodiment of a method for correcting an SRS-based DL channel estimate.

FIG. 13 is a flowchart diagram illustrating one embodiment of a method for correcting an SRS-based DL channel estimate.

### DETAILED DESCRIPTION

The present disclosure describes systems, methods, and apparatuses for correcting SRS-based DL channel estimates. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In some wireless communication systems, a UE is allowed to specify its maximum configured power P_{CMAX,f,c}(i.e., for a respective carrier frequency, f, and cell, c) in the range defined by Equation 1, below:

P_{CMAX_L,f,c}≤P_{CMAX,f,c}≤P_{CMAX_H,f,c} (Equation 1)

Additionally, some wireless communication systems may allow transmission power relaxations (i.e., power reductions) and these relaxations may be included in the definition of the lower bound P_{CMAX} (i.e., “P_{CMAX_L}”). As used herein, a transmission power relaxation refers to an adjustment to the output power, e.g., based on current operating conditions. For example, when the UE has a strong, robust communication link (i.e., a link exhibiting good quality), then it may reduce its transmission power to save energy and/or to mitigate inter-device interference. As another example, when the channel quality of the communication link degrades, then the UE may increase its transmission power to overcome poor channel conditions, e.g., by boosting a signal-to-noise ratio (SNR) or signal-to-interference-plus-noise ratio (SINR).

There has been discussion of whether it is necessary for the radio access network (RAN) entity (e.g., eNB or gNB) to have knowledge of the SRS power relaxations taken by the UE, so that the RAN entity can correct the SRS-based DL channel estimate for these power relaxations. However, certain power relaxations are only observed when the UE is transmitting SRS at near maximum power, and otherwise, the power at the SRS transmit ports is equal. The present disclosure considers whether allowed implementation losses other than ΔT_{RxSRS} should also be compensated at power levels below P_{CMAX}.

In addition to the SRS power relaxations, the channel estimation may also be degraded if there are differences in the trace losses between the UE receive antennas and the corresponding LNAs. These unknown trace losses are effectively part of the DL channel, and yet are not observed during the measurement of the SRS. The UE cannot compensate these trace losses, and thus the RAN entity (e.g., gNB) should correct the DL channel estimate for these losses, if known.

As a final issue, because P_{CMAX} is defined independently for each SRS port (i.e., an antenna port used to transmit SRS), the present disclosure also considers the expected behavior when SRS ports with different P_{CMAX} values are included in the same SRS set.

Described herein are solutions to correct SRS-based DL channel estimates. Beneficially, by correcting for the trace losses and the power relaxations, the radio network can generate a more accurate DL channel estimate thereby improving communication quality and performance.

As used herein, an antenna port is a logical entity which relates to, but does not correspond to, a physical antenna. As used herein, an antenna connector is associated with a single antenna. In general, an antenna port can be a linear combination of antennas and thus would not necessarily be associated with a single antenna connector. For example, in Third Generation Partnership Project (3GPP) specifications, an antenna port is more general than the physical antenna and is defined by the reference symbols transmitted from the antenna port and the resulting channel observed by these reference symbols.

However, in the present disclosure the terms “antenna port,” “transmit port,” and “SRS port” are not defined with respect to a linear combination of antenna, therefore these terms are used synonymously with “antenna connector.” However, in other embodiments the below solutions are applicable to the more general case in which an antenna port is a linear combination of antennas.

Aspects of the present disclosure are described in the context of a wireless communications system. Aspects of the present disclosure are further illustrated and described with reference to system diagrams, device diagrams, configuration parameter diagrams, and flowcharts.

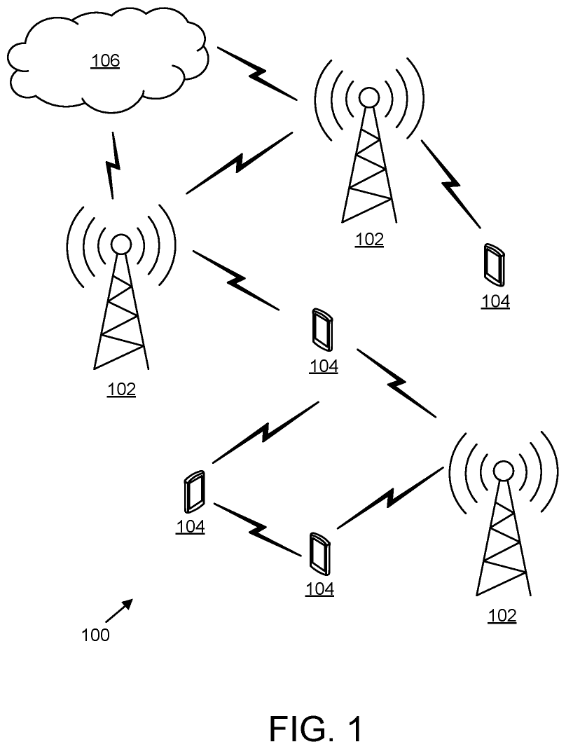

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a long-term evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (i.e., Wi-Fi), IEEE 802.16 (i.e., WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNB, a gNB, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink (SL). For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane (CP) entity that manages access and mobility (e.g., a mobility management entity (MME), an access and mobility management functions (AMF)) and a user plane (UP) entity that routes packets or interconnects to external networks (e.g., a serving gateway (S-GW), a Packet Data Network (PDN) gateway (P-GW), or a user plane function (UPF)). In some implementations, the CP entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For initial access, a UE 104 detects a candidate cell and performs DL synchronization. For example, the gNB (e.g., an embodiment of the NE 102) may transmit a synchronization signal and broadcast channel (SS/PBCH) transmission, referred to as a synchronization signal block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB.

Note that with beam-based communication, each DL beam may be associated with a respective SSB. In 3GPP NR, the gNB may transmit the maximum 64 SSBs and the maximum 64 corresponding copies of physical downlink control channel (PDCCH) and/or physical downlink shared channel (PDSCH) for delivery of system information block #1 (SIB1) in high frequency bands (e.g., 28 GHz).

In the following, instead of “slot,” the terms “mini-slot,” “subslot,” or “aggregated slots” can also be used, wherein the notion of slot/mini-slot/sub-slot/aggregated slots can be described as defined in 3GPP technical specification (TS) 38.211, TS 38.213, and/or TS 38.214. Throughout this disclosure reference to TS 38.211, TS 38.212, TS 38.213, TS 38.214 is associated with version 16.4.0 of the 3GPP specifications.

Several solutions to provide variable resource timing and size are described below. According to a possible embodiment, one or more elements or features from one or more of the described solutions may be combined.

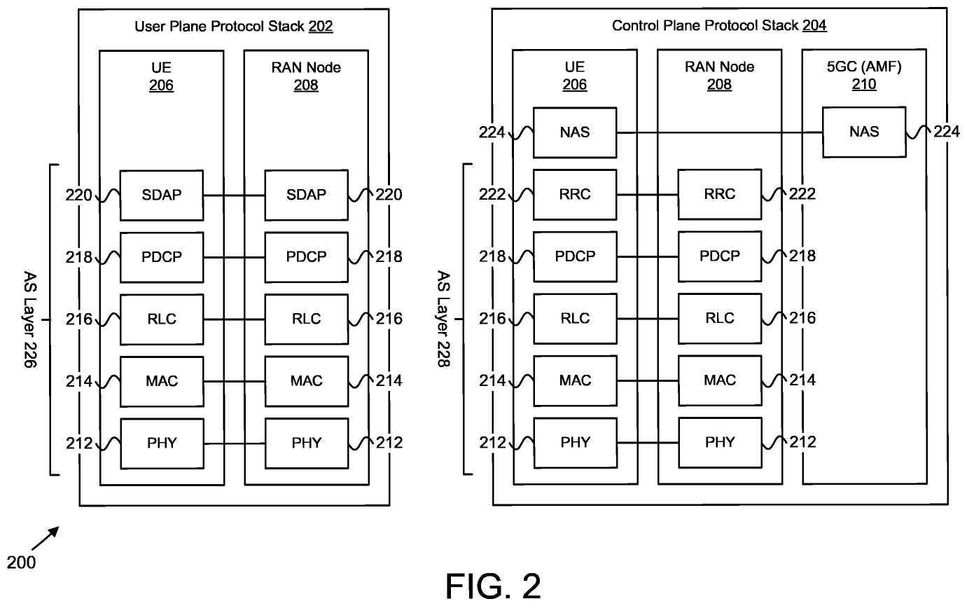

FIG. 2 illustrates an example of a protocol stack 200, in accordance with aspects of the present disclosure. In certain embodiments, the protocol stack 200 is an NR protocol stack for communication between the UE and the mobile network. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106.

As depicted, the protocol stack 200 comprises a UP protocol stack 202 and a CP protocol stack 204. The UP protocol stack 202 includes a physical (PHY) layer 212, a MAC sublayer 214, a radio link control (RLC) sublayer 216, a packet data convergence protocol (PDCP) sublayer 218, and a service data adaptation protocol (SDAP) layer 220. The CP protocol stack 204 includes a PHY layer 212, a MAC sublayer 214, a RLC sublayer 216, and a PDCP sublayer 218. The CP protocol stack 204 also includes a radio resource control (RRC) layer 222 and a non-access stratum (NAS) layer 224.

The AS layer 226 (also referred to as “AS protocol stack”) for the UP protocol stack 202 consists of at least SDAP, PDCP, RLC and MAC sublayers, and the physical layer. The AS layer 228 for the CP protocol stack 204 consists of at least RRC, PDCP, RLC and MAC sublayers, and the physical layer. The layer-1 (L1) includes the PHY layer 212. The layer-2 (L2) is split into the SDAP sublayer 220, PDCP sublayer 218, RLC sublayer 216, and MAC sublayer 214. The layer-3 (L3) includes the RRC layer 222 and the NAS layer 224 for the CP and includes, e.g., an internet protocol (IP) layer and/or PDU Layer (not depicted) for the UP. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of carrier aggregation and/or dual connectivity. The RRC layer 222 also manages the establishment, configuration, maintenance, and release of signaling radio bearers (SRBs) and data radio bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the protocol stack 200. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as transport blocks (TBs)) from MAC service data units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry UP data. On the other hand, the data from the MAC sublayer 214 is exchanged with the PHY layer 212 through transport channels, which are classified as UL or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of physical resource blocks (PRBs), etc.

Note that an LTE protocol stack may comprise a similar structure to the protocol stack 200, with the differences that the LTE protocol stack lacks the SDAP sublayer 220 in the AS layer 226, that an EPC replaces the 5GC 210, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in multiple-input multiple-output (MIMO) communication (also referred to as a “MIMO layer” or a “data stream”).

In general, the following discussion of channel estimation and correction of SRS-Based DL channel estimates occurs at the PHY layer 212.

Regarding the impact of SRS power relaxations on power control behavior, as noted above, various power relaxations are included in the definition of the lower bound P_{CMAX_L}, for example as shown in Equation 2, below:

$${P}_{CMAX\_L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RxSRS} , P - {MPR}_{c} ) \} \qquad ( Eq . 2 )$$

Here, the parameters P_{EMAX,c}, ΔT_{C,c}, P_{PowerClass}, ΔP_{PowerClass}, MPR_{c}, ΔMPR_{c}, A-MPR_{c}, ΔT_{IB,c}, ΔT_{RXSRS}, and P-MPR_{c} are as used in clause 6.2.4 of 3GPP TS 38.101-1, v17.9.0.

The allowed power relaxations can be divided into two types: Type 1 includes the MPR_{c}, ΔMPR_{c}, A-MPR_{c}, P-MPR_{c}, AP_{Powerclass}, while Type 2 includes the ΔT_{IB,c}, ΔT_{C,c}, ΔT_{RxSRS}.

Type 1 maximum power relaxations, such as the Maximum Power Reduction (MPR) and the Additional Maximum Power Reduction (A-MPR) are taken by the UE in order meet emissions, regulatory, or other requirements. The UE knows both the values of these relaxations and the conditions under which they are taken. It is also possible that the UE takes power relaxations less than the maximum value allowed. For this reason, let the notation ^{A} in

$${MPR}_{c}^{A} , Δ {MPR}_{c}^{A} , and A - {MPR}_{c}^{A}$$

denote the actual power relaxations taken by the UE.

In contrast, Type 2 power relaxations are not applied by the UE but are the result of implementation losses. These power relaxations exist at all output power levels unless compensated by the UE. Additionally, it is likely that the actual implementation losses are less than the maximum allowed. For this reason, let the notation ^{A} in

$$Δ {T}_{IB , c , j}^{A} , Δ {T}_{C , c , j}^{A} , and Δ {T}_{RxSRS , j}^{A}$$

denote the actual implementation losses for the j-th SRS port. Unless the device (i.e., UE) is calibrated so that these actual implementation losses are known, it will not be possible for the UE to accurately compensate these power relaxations at power levels below P_{CMAX,f,c}.

The power control equation for SRS from 3GPP TS 38.213 v17.4.0 is defined as follows. If a UE transmits SRS based on a configuration by SRS-ResourceSet on active UL bandwidth part (BWP) b of carrier f of serving cell c using SRS power control adjustment state with index 1, then the UE may determine the SRS transmission power P_{SRS,b,f,c}(i,qₛ,l) in SRS transmission occasion i (for SRS resource set q) using the following SRS power control equation:

$${P}_{SRS , b , f , c} ( i , {q}_{s} , l ) = min \{ \begin{matrix}{P}_{CMAX , f , c} ( i ) , \\ {P}_{O\_SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i , l )\end{matrix} \} [ dBm ] .$$

It should be noted in this equation that P_{CMAX,f,c}(i) is not a function of the SRS port within resource set qₛ and so there is an implicit assumption here that SRS ports within the same SRS resource set have the same value of P_{CMAX,f,c}(i). Since P_{CMAX,f,c}(i) is a function of the antenna port in TS 38.101-1, there is a question as to which value of P_{CMAX,f,c}(i) applies here.

Thus, it may be observed that even though P_{CMAX,f,c} is defined in 3GPP TS 38.101-1 to be a function of SRS port, the SRS power control equation:

$${P}_{SRS , b , f , c} ( i , {q}_{s} , l ) = min \{ \begin{matrix}{P}_{CMAX , f , c} ( i ) , \\ {P}_{O\_SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i , l )\end{matrix} \}$$

does not allow P_{CMAX,f,c}(i) to depend on the SRS port within the SRS resource set qₛ.

Accordingly, aspects of a first solution improve the SRS power control equation by defining P_{CMAX,f,c}(i,p) as P_{CMAX} for the p-th SRS port and, and furthermore, define

$${P}_{SRS , b , f , c} ( i , {q}_{s} , l , p ) = min \{ \begin{matrix}{P}_{CMAX , f , c} ( i , p ) , \\ {P}_{O\_SRS , b , f , c} ( {q}_{s} ) + 10 {log}_{10} ( {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i , l )\end{matrix} \} .$$

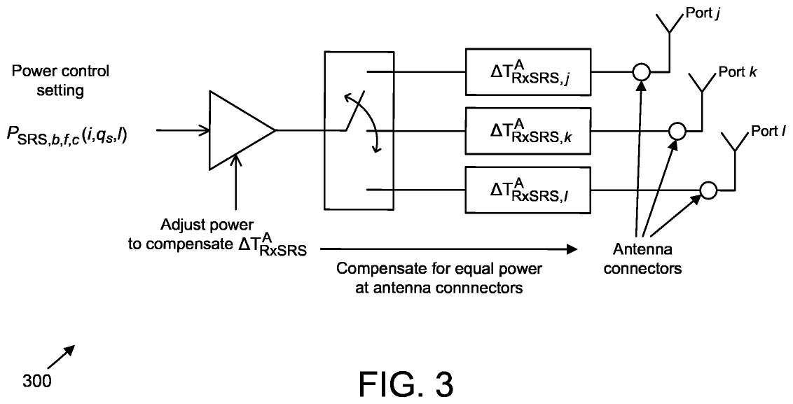

FIG. 3 illustrates an exemplary scenario 300 for compensation of

$$Δ {T}_{RxSRS}^{A}$$

implementation losses at a UE, in accordance with aspects of the disclosure. The scenario 300 considers the behavior of the output power versus the power control setting P_{SRS,b,f,c}(i,qₛ,l,p) in combination with the actual power relaxations

$$Δ {T}_{RxSRS}^{A} .$$

From FIG. 3, it can be observed that if the power amplification (PA) setting is not adjusted to compensate for the different losses

$$Δ {T}_{RxSRS}^{A} ,$$

then a single power control setting P_{SRS,b,f,c}(i,qₛ,l,p) will yield different power values at each of the antenna connectors. Furthermore, since the power control setting for the p-th SRS port is limited to P_{CMAX,f,c}(i,p), the output power at the p-th SRS will not achieve P_{CMAX,f,c}(i,p) at the antenna connector unless the losses

$$Δ {T}_{RxSRS}^{A}$$

are compensated as indicated in FIG. 3.

Thus, it may be observed that if the UE does not adjust the PA setting to compensate for the power relaxations

$$Δ {T}_{RxSRS}^{A} ,$$

then a single power control setting P_{SRS,b,f,c}(i,qₛ,l,p) will yield a different output power at each of the antenna connectors.

Additionally, since the power control setting for the p-th SRS port is limited to P_{CMAX,f,c}(i,p), the output power at the p-th SRS will not achieve P_{CMAX,f,c}(i,p) at the antenna connector unless the losses

$$Δ {T}_{RxSRS}^{A}$$

are compensated.

According to aspects of a second solution, the UE indicates whether the SRS relaxations

$$Δ {T}_{RxSRS}^{A}$$

are compensated so that the power at the antenna connectors is equal for all power settings such that the following condition is met:

$${P}_{SRS , b , f , c} ( i , {q}_{s} , l , p ) \leq {min}_{1 \leq p \leq 8} {P}_{CMAX , f , c} ( i , p )$$

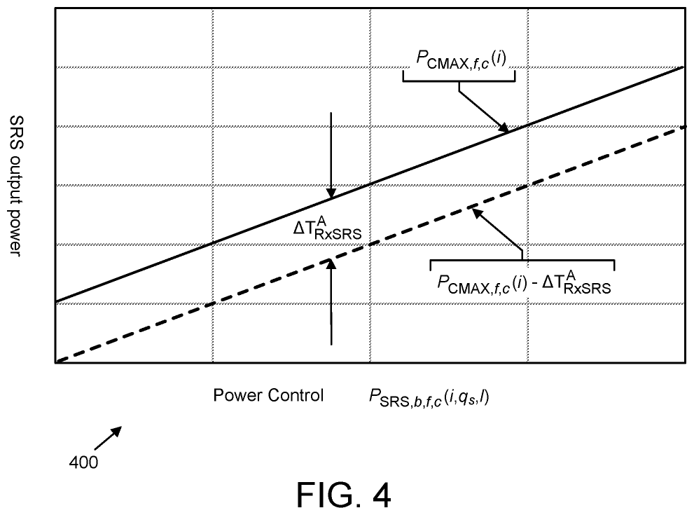

FIG. 4 illustrates an exemplary chart 400 depicting the SRS output power vs. power control with and without compensation of

$$Δ {T}_{RxSRS}^{A} ,$$

in accordance with aspects of the disclosure. In FIG. 4, the SRS output power is shown as a function of the power control setting P_{SRS,b,f,c}(i,qₛ,l,p) both when the implementation loss

$$Δ {T}_{RxSRS}^{A}$$

is compensated and when it is not. From this FIG. 4, it can be observed that if the implementation loss is not compensated, the SRS output power is shifted down by

$$Δ {T}_{RxSRS}^{A} ,$$

and furthermore, the maximum power at the antenna connector is reduced to

$${P}_{CMAX , f , c} ( i , p ) - Δ {T}_{RxSRS}^{A} .$$

Thus, it may be observed that unless the UE compensates the SRS relaxations as indicated in FIG. 3, the SRS output power will lag the power control setting P_{SRS,b,f,c}(i,qₛ,l,p) by

$$Δ {T}_{RxSRS , p}^{A} ,$$

in accordance with aspects of the disclosure. Since the maximum value of the power control setting P_{SRS,b,f,c}(i,qₛ,l,p) is P_{CMAX,f,c}(i,p), the maximum power at the antenna connector will be

$${P}_{CMAX , f , c} ( i , p ) - Δ {T}_{RxSRS , p}^{A} .$$

Since P_{CMAX,f,c}(i,p) was already reduced by ΔT_{RxSRS,p} (assuming the maximum configured power is equal to its lower bound) the reduction of P_{CMAX,f,c}(i,p) by

$$Δ {T}_{RxSRS , p}^{A}$$

without compensation by the PA has the effect of increasing the reduction of the maximum configured power to

$$2 \cdot Δ {T}_{RxSRS}^{A} .$$

It may also be observed that unless the SRS implementation loss

$$Δ {T}_{RxSRS , p}^{A}$$

is compensated by the UE, the total reduction in maximum configured power will be

$$2 \cdot Δ {T}_{RxSRS}^{A} .$$

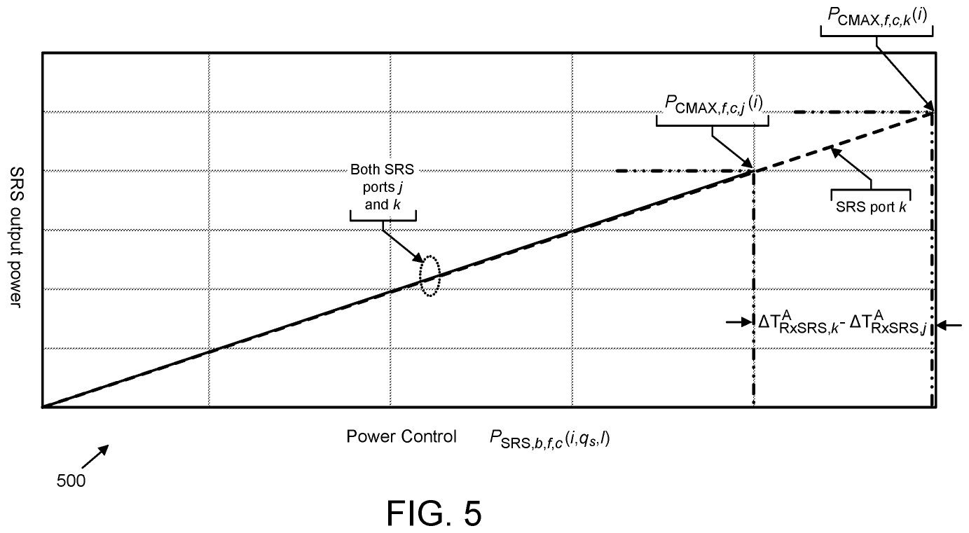

FIG. 5 illustrates an exemplary chart 500 depicting the power difference between SRS ports and power control with compensation of implementation losses

$$( i . e . , Δ {T}_{RxSRS}^{A} ) ,$$

in accordance with aspects of the present disclosure. In FIG. 5, the SRS output power is shown for SRS ports j and k as a function of the power control setting P_{SRS,b,f,c}(i,qₛ,l,p) for the case that the SRS power relaxations are compensated by the UE. In this FIG. 5, P_{CMAX,f,c,j}(i,p) and P_{CMAX,f,c,k}(i,p) denote the maximum configured power for SRS ports j and k, respectively, and

$$Δ {T}_{RxSRS , j}^{A} and Δ {T}_{RxSRS , k}^{A}$$

denote the actual SRS power relaxations.

From FIG. 5, it can be observed that there is no difference in the output power for the two SRS ports unless the power control setting is greater than P_{CMAX,f,c,j}(i,p). In this region, the output power for the k-th SRS port exceeds the power for the j-th port by the difference P_{SRS,b,f,c}(i,qₛ,l,p)−P_{CMAX,f,c,j}(i,p). It can also be noted that the difference in maximum power for the two SRS ports is given by

$$Δ {T}_{RxSRS , j}^{A} - Δ {T}_{RxSRS , k}^{A} .$$

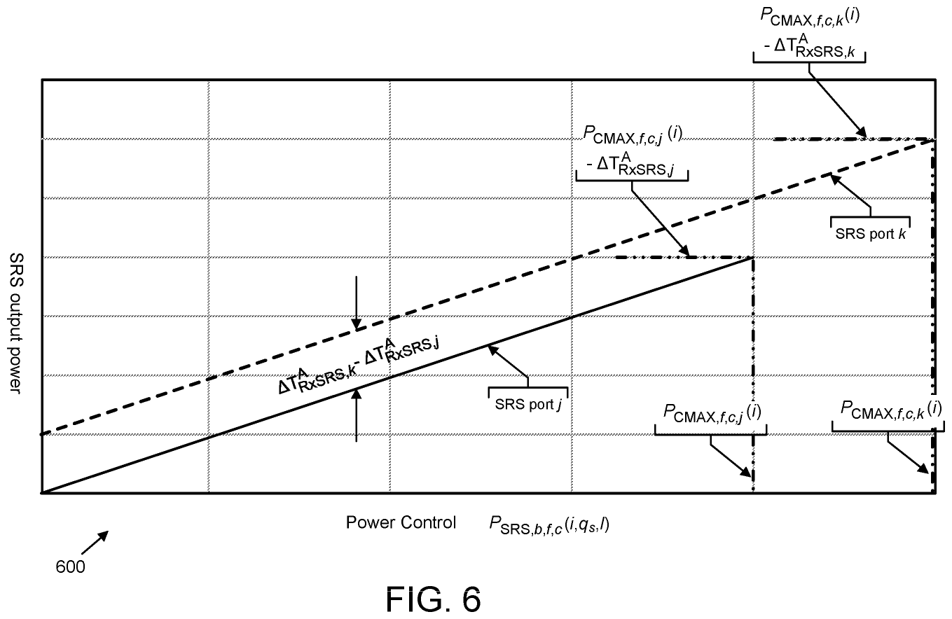

FIG. 6 illustrates an exemplary scenario 600 for the power difference between SRS ports and power control without compensation implementation losses

$$( i . e . , Δ {T}_{RxSRS}^{A} ) ,$$

in accordance with aspects of the disclosure. In FIG. 6, the SRS output power is shown for SRS ports j and k as a function of the power control setting P_{SRS,b,f,c}(i,qₛ,l) for the case that the SRS power relaxations are not compensated by the UE.

From FIG. 6, it can be observed that the difference in output power for the two SRS ports is given by

$$Δ {T}_{RxSRS , j}^{A} - Δ {T}_{RxSRS , k}^{A} .$$

Additionally, the reduction in the maximum output power is given by

$$2 \cdot Δ {T}_{RxSRS , j}^{A} and 2 \cdot Δ {T}_{RxSRS , k}^{A}$$

for the j-th and k-th SRS output ports, respectively. The difference in the maximum output power for the two SRS ports is given by

$$2 \cdot ( Δ {T}_{RxSRS , j}^{A} - Δ {T}_{RxSRS , k}^{A} ) .$$

According to aspects of a third solution, the values of the relaxations

$$\{ Δ {T}_{RxSRS , p}^{A} \}$$

can be used to correct the DL channel estimate at all power levels P_{SRS,b,f,c}(i,qₛ,l,p) if the UE transmitter does not compensate these relaxations. If the UE does compensate the SRS relaxations, then the values

$$\{ Δ {T}_{RxSRS , p}^{A} \}$$

can be used to correct the DL channel estimates when

$${P}_{SRS , b , f , c} ( i , {q}_{s} , l , p ) \geq {min}_{p} {P}_{CMAX , f , c} ( i , p ) .$$

Regarding the effect of unequal receive losses on channel estimation, so far, the need to correct DL channel estimates based on UL channel measurements has only focused on the effect of the allowed SRS power relaxations needed to account for switching and trace losses. However, there are also switching and trace losses between the antenna connectors and the LNA's. These receiver losses should also be considered when making corrections to DL channel estimates, especially if these losses are unequal.

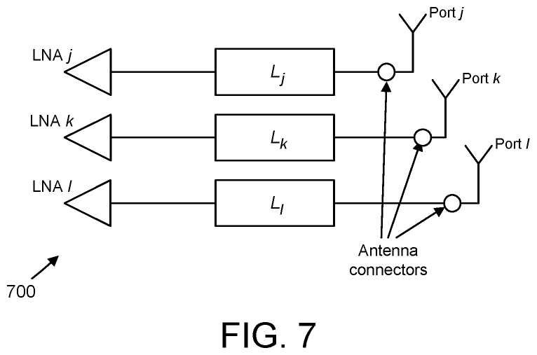

FIG. 7 illustrates an exemplary scenario 700 for receiver switching and trace losses between the antenna connectors and the LNAs, in accordance with aspects of the disclosure. As indicated in FIG. 7, let Lⱼ (in dB) denote the loss from the j-th antenna connector to the j-th LNA. As before, let

$$Δ {T}_{RxSRS , j}^{A}$$

(in dB) denote the loss from the PA to the j-th antenna connector.

For a gNB with M antennas and a UE with N antennas, let the M×N matrix H denote the channel between the gNB and the UE where Hᵢⱼ denotes the complex channel gain from the j-th UE antenna connector to the i-th gNB receive antenna. The losses {Lⱼ: 1≤j≤M} are additive to the channel between the gNB antennas and the UE antenna connectors and should be included in the DL channel estimate used by the gNB for rank, precoder and MCS selection. Let H′ denote the effective DL channel inclusive of the losses between the UE antenna connectors and the LNA's. The effective channel H′ can be expressed as

$${H}^{′} = H \cdot diag ( {l}_{1} , {l}_{2} , … , {l}_{N} )$$

where lⱼ denote the loss between the j-th UE antenna connector and the j-th LNA in linear terms, so that

$${l}_{j} = 1 {0}^{( - {L}_{j} / 20 )} ,$$

and diag(l₁, l₂, . . . , l_{N}) denotes a diagonal N×N matrix with the indicated values on the diagonal.

If the SRS relaxations are not compensated by the UE transmitter, the channel measured by the gNB is given by

$${H}_{meas} = H \cdot diag ( {t}_{1} , {t}_{2} , … , {t}_{N} )$$

$$where$$

$${t}_{j} = {10}^{( - Δ {T}_{RxSRS , j}^{A} / 20 )} .$$

The effective DL channel can then be expressed as

$${H}^{′} = {H}_{meas} \cdot {( diag ( {t}_{1} , {t}_{2} , … , {t}_{N} ) )}^{- 1} \cdot diag ( {l}_{1} , {l}_{2} , … , {l}_{N} ) = {H}_{meas} \cdot diag ( \frac{{l}_{1}}{{t}_{1}} , \frac{{l}_{2}}{{t}_{2}} , … , \frac{{l}_{N}}{{t}_{N}} ) .$$

Thus, it may be observed that if the SRS power relaxations are not compensated by the UE transmitter, the effective channel H′ between the gNB and the UE can be expressed as

$${H}^{′} = {H}_{meas} \cdot diag ( \frac{{l}_{1}}{{t}_{1}} , \frac{{l}_{2}}{{t}_{2}} , … , \frac{{l}_{N}}{{t}_{N}} ) .$$

Additionally, it may be observed that if the SRS power relaxations are compensated by the UE transmitter, the effective channel H′ between the gNB and the UE can be expressed as

$${H}^{′} = {H}_{meas} \cdot diag ( {l}_{1} , {l}_{2} , … , {l}_{N} ) .$$

According to aspects of a fourth solution, if the SRS power relaxations are compensated by the UE transmitter, the UE should report the receiver losses {Lⱼ} in addition to the SRS power relaxations

$$\{ Δ {T}_{RxSRS , j}^{A} \} .$$

If the UE does not compensate the SRS power relaxations, the UE may report the set of differences

$$\{ {L}_{j} - Δ {T}_{RxSRS , j}^{A} \} or \{ Δ {T}_{RxSRS , j}^{A} - {L}_{j} \} .$$

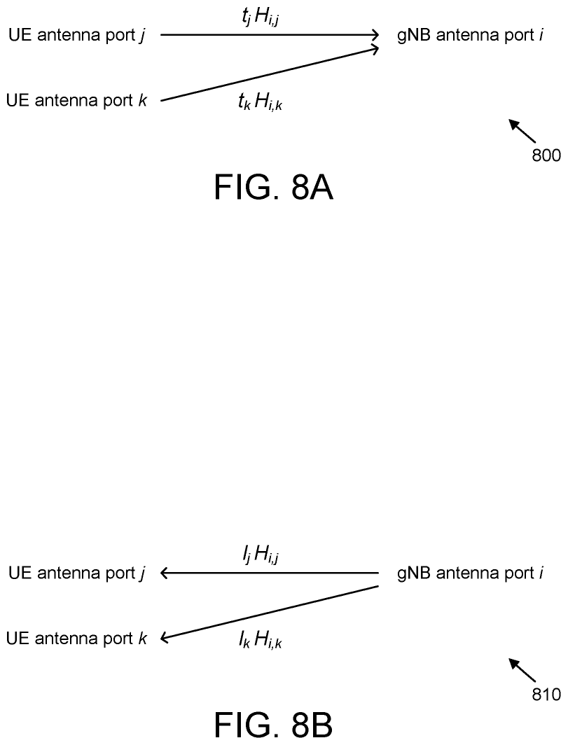

Regarding the measurement of SRS relaxations and receiver losses, the SRS relaxations could be determined by the network with the assistance of UE measurements. However, in the previous contributions the possibly unequal receiver losses between the antenna connectors and the LNAs were not considered. In this contribution, we consider the more general case in which these receiver losses are considered as shown in FIGS. 8A-8B.

FIG. 8A illustrates an exemplary scenario 800 for UE-to-gNB channel measurement, e.g., using SRS transmission, in accordance with aspects of the disclosure. As indicated in FIGS. 8A, the gNB uses reference symbols to measure the channel from the PA for the j-th UE antenna to the i-th gNB antenna and from the PA for the k-th UE antenna to the i-th gNB antenna as tⱼH_{i,j} and tₖH_{i,j}, respectively.

FIG. 8B illustrates an exemplary scenario 810 for gNB-to-UE channel measurement, e.g., using a DL reference signal (RS) transmission, in accordance with aspects of the disclosure. As indicated in FIGS. 8B, the UE uses reference symbols to measure the channels from the i-th gNB antenna to the LNA's for the j-th and k-th antenna ports as lⱼH_{i,j} and lₖ H_{i,j}, respectively, and signals the ratio |lₖH_{i,k}/lⱼH_{i,j}| to the gNB.

For each UE antenna port, the gNB can compute the ratio

$$\vert \frac{{l}_{k} {H}_{i , k}}{{l}_{j} {H}_{i , j}} \vert {\vert \frac{{t}_{k} {H}_{i , k}}{{t}_{j} {H}_{i , j}} \vert}^{- 1} = \frac{{l}_{k} / {t}_{k}}{{l}_{j} / {t}_{j}} .$$

So long as the ratio l₁/t₁ is known, the effective channel can then be computed in terms of these ratios as:

$$\begin{matrix}{H}^{′} = {H}_{meas} \cdot diag ( \frac{{l}_{1}}{{t}_{1}} , \frac{{l}_{2}}{{t}_{2}} , … , \frac{{l}_{N}}{{t}_{N}} ) \\ = {H}_{meas} \cdot ( {l}_{1} / {t}_{1} ) \cdot diag ( 1 , \frac{{l}_{2} / {t}_{2}}{{l}_{1} / {t}_{1}} , … , \frac{{l}_{2} / {t}_{2}}{{l}_{1} / {t}_{1}} )\end{matrix} ,$$

More generally, the effective channel can then be computed as

$${H}^{′} = {H}_{meas} \cdot ( {l}_{p} / {t}_{p} ) \cdot diag ( \frac{{l}_{1} / {t}_{1}}{{l}_{p} / {t}_{p}} , \frac{{l}_{2} / {t}_{2}}{{l}_{p} / {t}_{p}} , … , 1 , … , \frac{{l}_{N} / {t}_{N}}{{l}_{p} / {t}_{p}} ) ,$$

if the ratio lₚ/tₚ is known for at least one UE antenna port p. If lₚ/tₚ is not known for any UE antenna port, then the effective channel H′ can only be determined within a scale factor.

This same approach for channel determination can also be used if the UE compensates the SRS relaxations. In this case, tⱼ=1 for all UE antenna ports so that lⱼ/tⱼ=h; for all j.

Thus, it may be observed that, with consideration of both the SRS power relaxations and the associated receiver losses, the effective DL channel can be determined from Hₘₑₐₛ, the channel measured using the SRS, as

$${H}^{′} = {H}_{meas} \cdot ( {l}_{p} / {t}_{p} ) \cdot diag ( \frac{{l}_{1} / {t}_{1}}{{l}_{p} / {t}_{p}} , \frac{{l}_{2} / {t}_{2}}{{l}_{p} / {t}_{p}} , … , 1 , … , \frac{{l}_{N} / {t}_{N}}{{l}_{p} / {t}_{p}} ) ,$$

where the ratio the ratio lₚ/tₚ is known for the p-th antenna port.

According to aspects of a fifth solution, if the UE does not report receiver its receiver losses {Lⱼ} and its SRS power relaxations

$$\{ Δ {T}_{RxSRS , j}^{A} \}$$

or the difference between its receiver losses and its SRS power relaxations

$$\{ Δ {T}_{RxSRS , j}^{A} - {L}_{j} \}$$

to the gNB, then the UE should assist the gNB in determining the differences

$$\{ Δ {T}_{RxSRS , j}^{A} - {L}_{j} \}$$

by reporting the amplitudes or the ratio of amplitudes of measurements taken by multiple UE antenna ports of reference symbols transmitted from a gNB antenna port. Additionally, the UE should report the ratio lₚ/tₚ or the difference

$$\{ Δ {T}_{RxSRS , p}^{A} - {L}_{p} \}$$

for at least one antenna port p, if known.

In addition to the SRS power relaxations, channel estimation will also be degraded by if there are differences in the trace losses between the UE receive antennas and the corresponding LNA's. These unknown trace losses are effectively part of the DL channel, and yet are not observed during the measurement of the SRS. These trace losses cannot be compensated by the UE, and thus the gNB should correct the DL channel estimate for these losses if known.

To summarize the solutions described above:

According to aspects of the first solution, P_{CMAX,f,c}(i,p) is defined as P_{CMAX} for the p-th SRS port and, and furthermore, the SRS power control equation is defined as:

$${P}_{SRS , b , f , c} ( i , {q}_{s} , l , p ) = min \{ \begin{matrix}{P}_{CMAX , f , c} ( i , p ) , \\ {P}_{O \_ SRS , b , f , c} ( {q}_{s} ) + 10 {log}_{10} ( {N}_{SRS , b , f , c} ( i ) ) + \\ {α}_{SRS , b , f , c} ( {q}_{s} ) + {PL}_{b , f , c} ( {q}_{d} ) + {h}_{b , f , c} ( i , l )\end{matrix} \} .$$

According to aspects of the second solution, the UE should indicate if the SRS relaxations

$$Δ {T}_{RxSRS}$$

are compensated so that the power at the antenna connectors is equal for all power settings such that

$${P}_{SRS , b , fc} ( i , {q}_{s} , l , p ) \leq {min}_{1 \leq p \leq 8} {P}_{CMAX , f , c} ( i , p ) ,$$

According to aspects of the third solution, the values of the relaxations

$$\{ Δ {T}_{RxSRS , p}^{A} \}$$

can be used to correct the DL channel estimate at all power levels P_{SRS,b,f,c}(i,qₛ,l,p) if the UE transmitter does not compensate these relaxations. If the UE does compensate the SRS relaxations, then the values

$$\{ Δ {T}_{RxSRS , p}^{A} \}$$

can be used to correct the DL channel estimates when

$${P}_{SRS , b , f , c} ( i , {q}_{s} , l , p ) \geq {min}_{p} {P}_{CMAX , f , c} ( i , p ) .$$

According to aspects of the fourth solution, if the SRS power relaxations are compensated by the UE transmitter, the UE should report the receiver losses {Lⱼ} in addition to the SRS power relaxations

$$\{ Δ {T}_{R xSRS , j}^{A} \} .$$

If the UE does not compensate the SRS power relaxations, the UE may report the set of differences

$$\{ {L}_{j} - Δ {T}_{R xSRS , j}^{A} \} or \{ Δ {T}_{R xSRS , j}^{A} - {L}_{j} \} .$$

According to aspects of the fifth solution, if the UE does not report receiver its receiver losses {Lⱼ} and its SRS power relaxations

$$\{ Δ {T}_{RxSRS , j}^{A} \}$$

or the difference between its receiver losses and its SRS power relaxations

$$\{ Δ {T}_{RxSRS , j}^{A} - {L}_{j} \}$$

to the gNB, then the UE should assist the gNB in determining the differences

$$\{ Δ {T}_{RxSRS , j}^{A} - {L}_{j} \}$$

by reporting the amplitudes or the ratio of amplitudes of measurements taken by multiple UE antenna ports of reference symbols transmitted from a gNB antenna port. Additionally, the UE should report the ratio lₚ/tₚ or the difference

$$Δ {T}_{RxSRS , j}^{A} - {L}_{p}$$

for at least one antenna port p, if known.

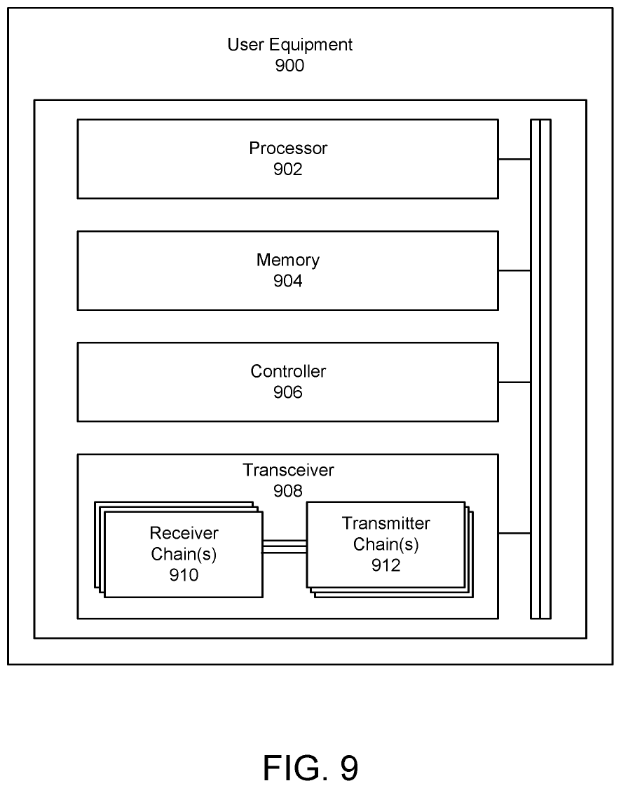

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a central processing unit (CPU), an ASIC, a field programable gate array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the UE functions described herein (e.g., executing, by the processor 902, instructions stored in the memory 904). For example, the processor 902 may support wireless communication at the UE 900 in accordance with examples as disclosed herein.

The UE 900 may be configured to or operable to support a means for identifying a power relaxation for an UL transmission. The UE 900 may be configured to or operable to support a means for determining that the power relaxation is compensated at the UE 900. The UE 900 may be configured to or operable to support a means for transmitting (e.g., to a BS) an indication that the power relaxation is compensated.

In some embodiments, the UE 900 is configured to transmit (e.g., to the BS) an indication that a respective power relaxation is not compensated, in response to determining that the respective power relaxation is not compensated. In certain embodiments, the UE 900 is configured to transmit (e.g., to the BS) a set of difference values.

In one embodiment, each difference value of the set of difference values indicates a difference between a receiver loss for a respective antenna connector and an actual relaxation value for the respective antenna connector. In another embodiment, each difference value of the set of difference values indicates a difference between an actual relaxation value for a respective antenna connector and a receiver loss for the respective antenna connector.

In some embodiments, the UL transmission comprises an SRS transmission, and wherein the power relaxation corresponds to an implementation loss corresponding to an SRS port. In certain embodiments, a power control setting for the SRS transmission is based on a configured maximum output power (i.e., P_{CMAX}) for the SRS port. In some embodiments, the determination that the power relaxation is compensated is based on compensating for equal power at antenna connectors of the UE.

In some embodiments, the UE 900 is configured to transmit (e.g., to the BS) power compensation assistance information. In certain embodiments, the power compensation assistance information comprises a set of channel measurements taken by multiple UE antenna ports of reference symbols transmitted from a network-side antenna port, and wherein the set of channel measurements comprises amplitude values and/or a ratio of amplitude values.

In certain embodiments, the power compensation assistance information comprises a set of ratio values corresponding to at least one antenna connector at the UE, each ratio value of the set of ratio values indicating a ratio of receiver loss to transmit power relaxation for a respective antenna connector. In certain embodiments, the power compensation assistance information comprises a set of difference values corresponding to at least one antenna connector at the UE, each difference value of the set of difference values indicating a difference between a receiver loss for a respective antenna connector and an actual relaxation value for the respective antenna connector.

The controller 906 may manage input and output signals for the UE 900. The controller 906 may also manage peripherals not integrated into the UE 900. In some implementations, the controller 906 may utilize an operating system (OS) such as iOS®, ANDROID®, WINDOWS®, or other operating systems (OSes). In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the receiving signal and obtain the transmitted data by reversing the modulation technique applied during transmission of the signal. The receiver chain 910 may include at least one decoder for decoding and processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

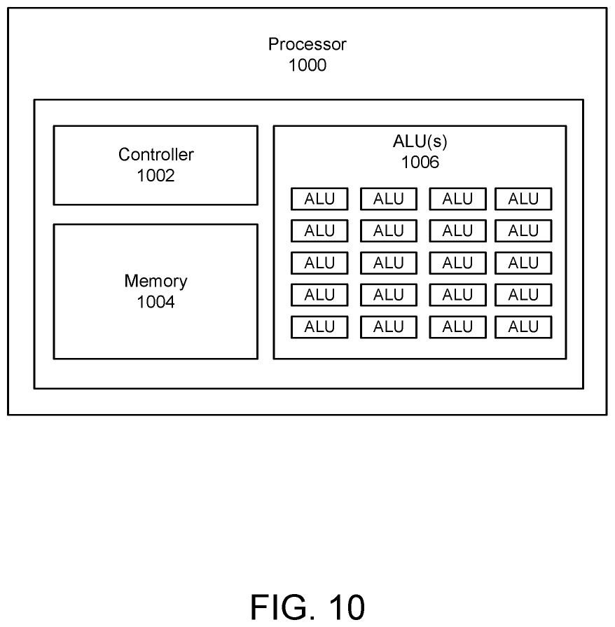

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. For example, the processor 1000 may perform one or more of the UE functions described herein. The processor 1000 may be configured to or operable to support a means for identifying a power relaxation for an UL transmission.

The processor 1000 may be configured to or operable to support a means for determining that the power relaxation is compensated at a UE associated with the processor 1000. The processor 1000 may be configured to or operable to support a means for transmitting (e.g., to a BS) an indication that the power relaxation is compensated.

In some embodiments, the processor 1000 is configured to transmit (e.g., to the BS) an indication that a respective power relaxation is not compensated, in response to determining that the respective power relaxation is not compensated. In certain embodiments, the processor 1000 is configured to transmit (e.g., to the BS) a set of difference values.

In one embodiment, each difference value of the set of difference values indicates a difference between a receiver loss for a respective antenna connector and an actual relaxation value for the respective antenna connector. In another embodiment, each difference value of the set of difference values indicates a difference between an actual relaxation value for a respective antenna connector and a receiver loss for the respective antenna connector.

In some embodiments, the UL transmission comprises an SRS transmission, and wherein the power relaxation corresponds to an implementation loss corresponding to an SRS port. In certain embodiments, a power control setting for the SRS transmission is based on a configured maximum output power (i.e., P_{CMAX}) for the SRS port. In some embodiments, the determination that the power relaxation is compensated is based on compensating for equal power at antenna connectors of the UE.

In some embodiments, the processor 1000 is configured to transmit (e.g., to the BS) power compensation assistance information. In certain embodiments, the power compensation assistance information comprises a set of channel measurements taken by multiple UE antenna ports of reference symbols transmitted from a network-side antenna port, and wherein the set of channel measurements comprises amplitude values and/or a ratio of amplitude values.

In certain embodiments, the power compensation assistance information comprises a set of ratio values corresponding to at least one antenna connector at the UE, each ratio value of the set of ratio values indicating a ratio of receiver loss to transmit power relaxation for a respective antenna connector. In certain embodiments, the power compensation assistance information comprises a set of difference values corresponding to at least one antenna connector at the UE, each difference value of the set of difference values indicating a difference between a receiver loss for a respective antenna connector and an actual relaxation value for the respective antenna connector.

In further embodiments, the processor 1000 may perform one or more of the RAN functions described herein. For example, the processor 1000 may be configured to or operable to support a means for receiving (e.g., from a UE) an indication of whether a power relaxation is compensated for an UL transmission.

The processor 1000 may be configured to or operable to support a means for determining a set of power relaxation values for the UL transmission. The processor 1000 may be configured to or operable to support a means for correcting a DL channel estimate based on the set of power relaxation values and further based on the indication.

In some embodiments, the processor 1000 is configured to receive (e.g., from the UE) an indication that the power relaxation is not compensated. In some embodiments, to correct the DL channel estimate based on the set of power relaxation values, the processor 1000 is configured to correct at all power levels in response to the indication that the power relaxation is not compensated.

In some embodiments, the processor 1000 is configured to receive (e.g., from the UE) power compensation assistance information. In certain embodiments, the power compensation assistance information comprises a set of difference values, each difference value of the set of difference values indicating a difference between a receiver loss for a respective antenna connector and an actual relaxation value for the respective antenna connector. In such embodiments, the correction of the DL channel estimate may be based at least in part on the set of difference values.

In some embodiments, the processor 1000 is configured to receive (e.g., from the UE) an indication that the power relaxation is compensated. In such embodiments, the correction of the DL channel estimate may be based at least in part on a comparison of the set of power relaxation values to a threshold value. In certain embodiments, the threshold value corresponds to a smallest per-port configured maximum output power (i.e., P_{CMAX}) for a plurality of SRS ports.

In some embodiments, the processor 1000 is configured to receive (e.g., from the UE) a set of receiver loss values. In some embodiments, the processor 1000 is configured to receive an SRS transmission using an SRS port, wherein the DL channel estimate is based on the received SRS transmission.

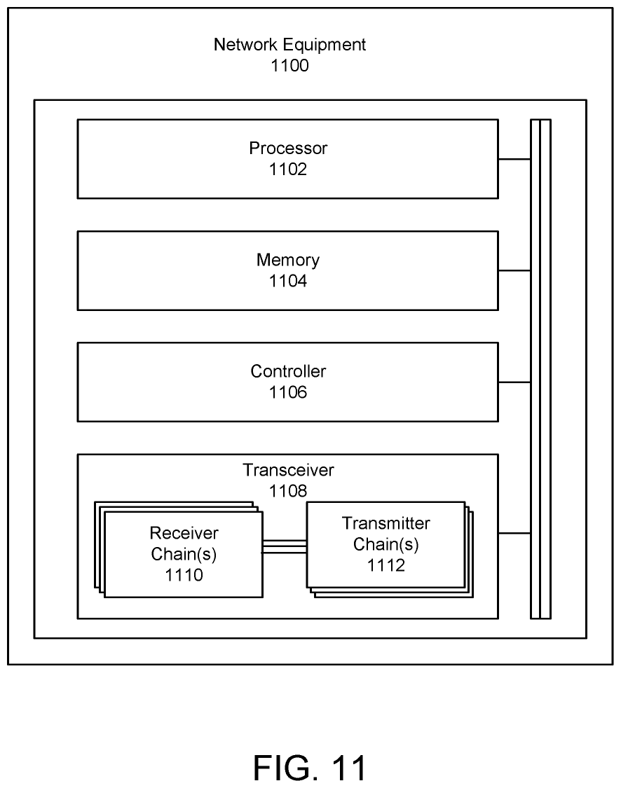

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the RAN functions described herein (e.g., executing, by the processor 1102, instructions stored in the memory 1104). For example, the processor 1102 may support wireless communication at the NE 1100 in accordance with examples as disclosed herein.

The NE 1100 may be configured to or operable to support a means for receiving (e.g., from a UE) an indication of whether a power relaxation is compensated for an UL transmission. The NE 1100 may be configured to or operable to support a means for determining a set of power relaxation values for the UL transmission. The NE 1100 may be configured to or operable to support a means for correcting a DL channel estimate based on the set of power relaxation values and further based on the indication.

In some embodiments, the NE 1100 is configured to receive (e.g., from the UE) an indication that the power relaxation is not compensated. In some embodiments, to correct the DL channel estimate based on the set of power relaxation values, the NE 1100 is configured to correct at all power levels in response to the indication that the power relaxation is not compensated.

In some embodiments, the NE 1100 is configured to receive (e.g., from the UE) power compensation assistance information. In certain embodiments, the power compensation assistance information comprises a set of difference values, each difference value of the set of difference values indicating a difference between a receiver loss for a respective antenna connector and an actual relaxation value for the respective antenna connector. In such embodiments, the correction of the DL channel estimate may be based at least in part on the set of difference values.

In some embodiments, the NE 1100 is configured to receive (e.g., from the UE) an indication that the power relaxation is compensated. In such embodiments, the correction of the DL channel estimate may be based at least in part on a comparison of the set of power relaxation values to a threshold value. In certain embodiments, the threshold value corresponds to a smallest per-port configured maximum output power (i.e., P_{CMAX}) for a plurality of SRS ports.

In some embodiments, the NE 1100 is configured to receive (e.g., from the UE) a set of receiver loss values. In some embodiments, the NE 1100 is configured to receive an SRS transmission using an SRS port, wherein the DL channel estimate is based on the received SRS transmission.

The controller 1106 may manage input and output signals for the NE 1100. The controller 1106 may also manage peripherals not integrated into the NE 1100. In some implementations, the controller 1106 may utilize an OS such as iOS®, ANDROID®, WINDOWS®, or other OSes. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receiving the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receiving signal and obtain the transmitted data by reversing the modulation technique applied during transmission of the signal. The receiver chain 1110 may include at least one decoder for decoding and processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

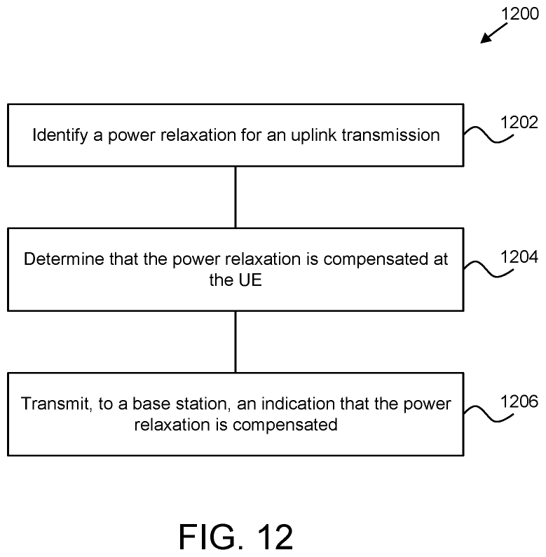

FIG. 12 illustrates a flowchart of a method 1200 in accordance with aspects of the present disclosure. The operations of the method 1200 may be implemented by a UE as described herein. In some implementations, the UE may execute a set of instructions to control the function elements of the UE to perform the described functions.

At Step 1202, the method 1200 may include identifying a power relaxation for an UL transmission. The operations of Step 1202 may be performed in accordance with examples as described herein. In some implementations, aspects of the operations of Step 1202 may be performed by a UE as described with reference to FIG. 9.

At Step 1204, the method 1200 may include determining that the power relaxation is compensated at the UE. The operations of Step 1204 may be performed in accordance with examples as described herein. In some implementations, aspects of the operations of Step 1204 may be performed by a UE as described with reference to FIG. 9.

At Step 1206, the method 1200 may include transmitting, to abase station, an indication that the power relaxation is compensated. The operations of Step 1206 may be performed in accordance with examples as described herein. In some implementations, aspects of the operations of Step 1206 may be performed by a UE as described with reference to FIG. 9.

It should be noted that the method 1200 described herein describes one possible implementation, and that the operations and the steps may be rearranged or otherwise modified and that other implementations are possible.

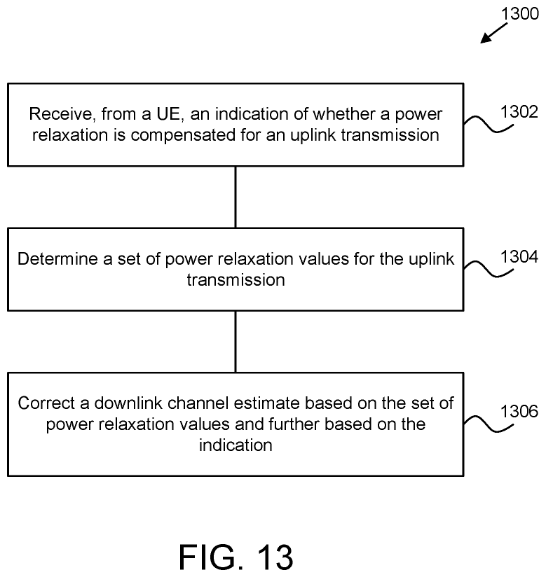

FIG. 13 illustrates a flowchart of a method 1300 in accordance with aspects of the present disclosure. The operations of the method 1300 may be implemented by a BS as described herein. In some implementations, the BS may execute a set of instructions to control the function elements of the BS to perform the described functions.

At Step 1302, the method 1300 may include receiving, from a UE, an indication of whether a power relaxation is compensated for an UL transmission. The operations of Step 1302 may be performed in accordance with examples as described herein. In some implementations, aspects of the operations of Step 1302 may be performed by a NE as described with reference to FIG. 11.

At Step 1304, the method 1300 may include determining a set of power relaxation values for the UL transmission. The operations of Step 1304 may be performed in accordance with examples as described herein. In some implementations, aspects of the operations of Step 1304 may be performed by a NE as described with reference to FIG. 11.

At Step 1306, the method 1300 may include correcting a DL channel estimate based on the set of power relaxation values and further based on the indication. The operations of Step 1306 may be performed in accordance with examples as described herein. In some implementations, aspects of the operations of Step 1306 may be performed by a NE as described with reference to FIG. 11.

It should be noted that the method 1300 described herein describes one possible implementation, and that the operations and the steps may be rearranged or otherwise modified and that other implementations are possible.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
identify a power relaxation for an uplink (UL) transmission;
determine that the power relaxation is compensated at the UE; and
transmit, to a base station, an indication that the power relaxation is compensated.

2. The UE of claim 1, wherein the at least one processor is configured to cause the UE to transmit, to the base station, an indication that a respective power relaxation is not compensated, in response to determining that the respective power relaxation is not compensated.

3. The UE of claim 2, wherein the at least one processor is configured to cause the UE to transmit, to the base station, a set of difference values, and wherein each difference value of the set of difference values indicates a difference between a receiver loss for a respective antenna connector and an actual relaxation value for the respective antenna connector.

4. The UE of claim 2, wherein the at least one processor is configured to cause the UE to transmit, to the base station, a set of difference values, and wherein each difference value of the set of difference values indicates a difference between an actual relaxation value for a respective antenna connector and a receiver loss for the respective antenna connector.

5. The UE of claim 1, wherein the UL transmission comprises a sounding reference signal (SRS) transmission, and wherein the power relaxation corresponds to an implementation loss corresponding to an SRS port.

6. The UE of claim 5, wherein a power control setting for the SRS transmission is based on a configured maximum output power (P_{CMAX}) for the SRS port.

7. The UE of claim 1, wherein the at least one processor is configured to determine that the power relaxation is compensated at the UE based on a compensation for equal power at antenna connectors of the UE.

8. The UE of claim 1, wherein the at least one processor is configured to cause the UE to transmit, to the base station, power compensation assistance information.

9. The UE of claim 8, wherein the power compensation assistance information comprises a set of channel measurements taken by multiple UE antenna ports of reference symbols transmitted from a network-side antenna port, and wherein the set of channel measurements comprises amplitude values, or a ratio of amplitude values, or both.

10. The UE of claim 8, wherein the power compensation assistance information comprises a set of ratio values corresponding to at least one antenna connector at the UE, each ratio value of the set of ratio values indicating a ratio of receiver loss to transmit power relaxation for a respective antenna connector.

11. The UE of claim 8, wherein the power compensation assistance information comprises a set of difference values corresponding to at least one antenna connector at the UE, each difference value of the set of difference values indicating a difference between a receiver loss for a respective antenna connector and an actual relaxation value for the respective antenna connector.

12. A processor for wireless communication, comprising:
at least one controller coupled with at least one memory and configured to cause the processor to:
identify a power relaxation for an uplink (UL) transmission;
determine that the power relaxation is compensated at a user equipment (UE) associated with the processor; and
transmit, to a base station, an indication that the power relaxation is compensated.

13. A base station for wireless communication, comprising:
at least one memory; and
at least one processor coupled with the at least one memory and configured to cause the base station to:
receive, from a user equipment (UE), an indication of whether a power relaxation is compensated for an uplink (UL) transmission;
determine a set of power relaxation values for the UL transmission; and
correct a downlink (DL) channel estimate based on the set of power relaxation values and further based on the indication.

14. The base station of claim 13, wherein the at least one processor is configured to cause the base station to receive, from the UE, an indication that the power relaxation is not compensated, and wherein to correct the DL channel estimate based on the set of power relaxation values, the at least one processor is configured to cause the base station to correct at all power levels in response to the indication that the power relaxation is not compensated.

15. The base station of claim 14, wherein the at least one processor is configured to cause the base station to receive, from the UE, a set of difference values, each difference value of the set of difference values indicating a difference between a receiver loss for a respective antenna connector and an actual relaxation value for the respective antenna connector, wherein a correction of the DL channel estimate is further based on the set of difference values.

16. The base station of claim 13, wherein the at least one processor is configured to cause the base station to receive, from the UE, an indication that the power relaxation is compensated, wherein a correction of the DL channel estimate based on the set of power relaxation values is further based on a comparison of the set of power relaxation values to a threshold value.

17. The base station of claim 16, wherein the threshold value corresponds to a smallest per-port configured maximum output power (P_{CMAX}) for a plurality of sounding reference signal (SRS) ports.

18. The base station of claim 13, wherein the at least one processor is configured to cause the base station to receive, from the UE, a set of receiver loss values.

19. The base station of claim 13, wherein the at least one processor is configured to cause the base station to receive a sounding reference signal (SRS) transmission using an SRS port, wherein the DL channel estimate is based on the received SRS transmission.

20. A method performed by a base station, the method comprising:
receiving, from a user equipment (UE), an indication of whether a power relaxation is compensated for an uplink (UL) transmission;
determining a set of power relaxation values for the UL transmission; and
correcting a downlink (DL) channel estimate based on the set of power relaxation values and further based on the indication.
